(19) United States
(12) Patent Application Publication
(10) Pub. No.: US 2009/0156845 A1
(43) Pub. Date: Jun. 18, 2009

(54) Acrylate Hybride Polymer Based On Natural Fatty Acids And Method For The Manufacture Thereof

(75) Inventors: Nina Heiskanen, Helsinki (FI); Pia Willberg, Espoo (FI); Salme Koskimies, Helsinki (FI); Janne Hulkko, Lohja (FI); Pirita Ushanov, Helsinki (FI); Sirkka-Liisa Maunu, Helsinki (FI)

Correspondence Address: BIRCH STEWART KOLASCH & BIRCH, PO BOX 747, FALLS CHURCH, VA, 22040-0747, US

(73) Assignee: Valtion teknillinen tutkimuskesus, Espoo (FI)

(21) Appl. No.: 12/224,613

(22) PCT Filed: Mar. 2, 2007
(86) PCT No.: PCT/FI2007/050114

§ 371 Date: Oct. 30, 2008

(30) Foreign Application Priority Data
Mar. 6, 2006 (FI) 20065151

(51) Int. Cl. C09D 191/00; C08F 242/00; C11C 3/00; C09J 191/00

(52) U.S. Cl. 554/165; 554/219; 554/163

(57) ABSTRACT

The invention relates to acrylate modified, natural fatty acid based hybride polymers, and to a method for their preparation. The invention also relates to the use of the modified natural fatty acid based hybride polymers as binding agents especially in water based coatings, adhesives and composites and as environmentally friendly wood impregnating agents. The acrylate-modified natural fatty acid based hybride polymer is a block polymer formed of acrylate segments and fatty acid segments.

### FIELD OF THE INVENTION

The invention relates to natural fatty acid based hybride polymers, modified with reactive monomers and especially with acrylates, and to a method for the manufacture thereof. The invention also relates to the use of the modified natural fatty acid based hybride polymers as binding agents especially in water based coatings, adhesives and composites and also as environmentally friendly wood impregnating agents.

### STATE OF THE ART

The use of water based coatings and especially latex based coatings has increased continuously in consequence of the positive environmental effects of latex based products and easy cleanability with water of the equipment used for application. The popularity of solvent-based alkyd paints has decreased mainly because of the volatile organic components (VOC) that they contain. Alkyd paints have anyhow some remarkable advantages compared to latex paints, such as compatibility especially with wood and modified wood materials, such as thermo-wood and impregnated wood products, as well as good surface gloss and hardness.

The use of products manufactured from renewable raw materials or biomaterials like biocomposites is continuously increasing. This is due to more good properties of these products, which are among other things biodegradability, recyclability and low toxicity of the products. Of their volume the most important of present biocomposites are linen, hemp and wood fibre based composites. In order to reach as high as possible proportion of raw materials derived from natural materials in the biocomposites it is generally desirable that also the additives used in the manufacture are of bio-origin.

Emulsion polymerisation is a known method for producing synthetic latexes functioning as coating agents and binding agents (binders), such as styrene-butadiene copolymers, acrylic polymers and poly(vinyl acetate). In emulsion polymerisation typically water, a monomer or a monomer mixture, a surface-active agent or surfactant and a polymerisation initiator are used. In the field also emulsion polymerisation-like miniemulsion polymerisation methods are known wherein often additionally e.g. a co-surfactant is used.

From U.S. Pat. No. 6,369,135 a miniemulsion polymerisation method is known for the preparation of a latex suited for coating applications, wherein reaction product or alkyd resin of diol or polyol, such as ethylene glycol or glycerol and a mono or polybasic acid, such as phthalic anhydride and the resin being modified with linen seed or soybean oil, is dissolved in an ethylenically unsaturated monomer, such as a vinyl or acrylate monomer. The mixture is miniemulsion polymerised in the presence of water and a surfactant, preferably additionally with a co-surfactant. As a result latex comprising polymer particles is obtained, wherein the alkyd is grafted to an acrylate polymer skeleton or vice versa an acrylate is grafted to an alkyd polymer skeleton. As products typically large-sized polymers are obtained having a relatively high molecular weight.

In the emulsion polymerisation methods known in the art large-sized molecules are typically allowed to react, whereby undesired side reactions occur, such as crosslinking and gelling. Additionally, precipitations are formed in the coating compositions prepared from the large-sized polymers, which precipitations shorten the shelf life of these products.

Based on the above it can be seen that there exists need to provide new modified natural fatty acid based hybride polymers and to develop a simple method for the manufacture thereof.

### OBJECT OF THE INVENTION

An object of the invention is to provide acrylate-modified natural fatty acid based hybride polymers.

A further object of the invention is a method for the manufacture of acrylate-modified natural fatty acid based hybride polymers.

A still further object of the invention is a method for the manufacture of emulsions from acrylate-modified natural fatty acid based hybride polymers.

A still further object of the invention is the use of acrylate-modified natural fatty acid based hybride polymers as binding agents in water based coatings, adhesives, paints, combination products sand composites and as wood impregnating agents.

The characterising features of the acrylate-modified natural fatty acid based hybride polymers according to the invention, of the method for their manufacture and their use are presented in the patent claims.

### SUMMARY OF THE INVENTION

Acrylate-modified natural fatty acid based hybride polymers refer here to a polymer formed of acrylate segments and fatty acid segments, having a molecular weight of 800-6,000,000 and in which the fatty acid segment having a molecular weight ranging between 200-20,000 may comprise fatty acids or mono- and/or oligoesters of fatty acids. The polymer is mainly of block polymer type.

The invention relates to acrylate-modified natural fatty acid based hybride polymers, to a method for their manufacture and to their use as binding agents in coatings, adhesives, paints and composites and also as components in wood impregnating agents.

In the method according to the invention, acrylate monomers react with conjugated or non-conjugated natural fatty acids or natural fatty acid esters containing double bonds, whereby an acrylate-modified natural fatty acid based hybride polymer is formed.

The acrylate-modified natural fatty acid based hybride polymer according to the invention is prepared by a emulsion polymerisation method. Acrylate monomer or acrylate monomers are dispersed in presence of one or more surfactants and optionally one or more co-surfactants to an emulsion, and then the acrylate monomer or acrylate monomers are polymerised in the presence of a free radical initiator and a fatty acid starting material containing reactive double bonds.

The product emulsion or acrylate-modified natural fatty acid based hybride polymer contains polymer particles, in which to the double bonds of the fatty acids of the starting material acrylate polymer chains have been grafted, e.g. to the fatty acid side chain an acrylate polymer segment is attached.

### DETAILED DESCRIPTION OF THE INVENTION

It has been surprisingly found that a stable emulsion can be obtained by allowing acrylate monomers to react with double bonds of natural fatty acids or natural fatty acid esters, e.g. with natural oils or tall oil fatty acid mixtures containing conjugated or non-conjugated double bonds. The acrylate-modified natural fatty acid based hybride polymer can be further dispersed/emulsified with an alkyd resin whereby a stable emulsion is formed.

The acrylate-modified natural fatty acid based hybride polymer according to the invention comprises natural fatty acids or natural fatty acid esters such as fatty acid mixtures obtained from natural oils, vegetable fatty acid mixtures, natural oils containing fatty acid esters, and natural oil based oligoesters, said fatty acids or fatty acid esters being modified with acrylate monomers.

Fatty acid starting material containing reactive double bonds refer here to natural fatty acids and natural fatty acid esters, particularly natural fatty acid mixtures and natural fatty acid ester mixtures, containing fatty acids containing double bonds or corresponding esters, and which exist e.g. in plants, trees and especially natural oils, tall oil fatty acid mixtures and in fatty acid mixtures of suberin and cutin and the double bonds can be conjugated or non-conjugated. With natural oils are meant here natural oils containing conjugated or non-conjugated double bonds, such as plant oil, preferably linen seed oil, soybean oil, rapeseed oil, rape oil, sunflower oil, olive oil etc.

Tall oil fatty acid mixture refers especially to a fatty acid mixture separated from the tall oil side product of wood processing industry, the typical fatty acid composition of which is presented in the following. The fatty acid mixture of tall oil contains about 50% (45-55%) of linolic acid and other diunsaturated C18 fatty acids, including conjugated acids, about 35% (30-45%) of oleic acid, about 7% (2-10%) of polyunsaturated fatty acids, about 2% (0.5-3%) of saturated fatty acids and at most 3% (0.5-3%) of rosin acids calculated as weight percents.

Suggested fatty acid compositions of some natural oils are presented in following Table 1:

TABLE 1

| | Fatty acid composition (% by weight) | | | |
|---|---|---|---|---|
| | | Linen seed | | Tall oil fatty |
| Fatty Acid | Soy oil | oil | Rapeseed oil | acid mixture |
| saturated | | | | |
| C₁₄ myristic acid | 0.1 | | | |
| C₁₆ palmitic acid | 10.5 | 6 | 5 | |
| C₁₈ stearic acid | 2 | 3.5 | 2 | 2 |
| C₂₀ arachidic acid | 0.2 | | | 1 |
| unsaturated | | | | |
| C_{16:1} palmitoleic acid | | 0.5 | | |
| C_{18:1} oleic acid | 22.3 | 19 | 63 | 59 |
| C_{20:1} eicosenoic acid | 0.9 | | 1 | 1 |
| C_{18:2} linolic acid | 54.5 | 14 | 20 | 37 |
| C_{18:3} linolenic acid | 8.3 | 57 | 9 | |
| altogether | 98.8 | 100 | 100 | 100 |

Acrylate monomers refer here to acrylate and methacrylate monomers such as butyl, ethyl, methyl, 2-ethylhexyl acrylate and butyl, ethyl, methyl, 2-ethylhexyl methacrylate, acrylic and methacrylic acid, a mixture of more acrylate monomers as well as a mixture of an acrylate or methacrylate with styrene or vinyl alcohol or vinyl acetate. Preferable acrylate monomers are butyl acrylate, methyl methacrylate and butyl methacrylate.

The acrylate-modified natural fatty acid based hybride polymer according to the invention is manufactured by emulsion polymerising of reactive double bonds containing fatty acid starting material such as natural fatty acids or natural fatty acid esters with acrylate monomer in an aqueous solution in presence of radical catalysts (free radical initiators) at 30-100, preferably 50-90° C., whereby a stable emulsion is formed. Typical polymerisation time ranges between 1 and 6 hours.

In the method acrylate monomer or acrylate monomers and water are dispersed in the presence of one or more surfactants and optionally one or more co-surfactants to an emulsion, then the acrylate monomer or acrylate monomers are polymerized in the presence of free radical initiator and fatty acid starting material containing reactive double bonds.

Optionally the acrylate monomer(s), natural fatty acid mixture or natural fatty acid ester mixture and one or more surfactants, water and optionally one or more cosurfactants (hydrophobe) are mixed together using if required warming, typically 20-80° C./1-120 min, preferably 25-65° C./1-30 min, after which pH of the solution is adjusted with a base between pH 6-9. Suitable bases for adjusting pH are e.g. aqueous solutions of NaHCO₃, KOH, NH₃ and the like. The reaction mixture is then emulsified to an aqueous solution optionally containing one or more surfactants. The emulsifying can be carried out either by adding the organic phase into the aqueous phase or vice versa, agitating at the same time vigorously, typically for 1-180 min, preferably 5-60 min. The mixing can also be carried out with a high efficiency mixing method or the emulsion first formed is treated with high shear force blender in order to form emulsion droplets. Typically ultrasonication may be used, 1-60 min, preferably 5-30 min, or a high shear force blender using a speed of revolution of 200-50,000 rpm, preferably 1,000-25,000 rpm, for 0.5-10 min, preferably 1-5 min. A suitable high efficiency blender is e.g. Ultra Turrax homogeniser. The emulsion is transferred to a polymerising reactor and the reaction is warmed to a temperature of 30-90° C., preferably 55-75° C. When the content of the reactor has reached a temperature of 45-85° C., an aqueous solution of polymerising initiator is added if the polymerising initiator hasn't been added earlier already. The polymerising is carried at 30-100° C., preferably 55-80° C., and the polymerising time is 1-6 hours, preferably 2-4 hours, while the mixing speed is of 100-2,000 rpm, preferably 300-500 rpm. After the reaction time the reaction mixture is cooled to room temperature, if necessary the pH is adjusted to the range of 7-9 and additives are added, such as biocide. The dry matter content of the emulsion is typically 8-85, preferably 35-60% and conversion of the monomer 50-100%.

The ratio of natural fatty acids or natural fatty acid esters to the acrylate monomer in the emulsion polymerisation method is typically between 30-70:70-30 weight/weight.

The surfactant or surface-active agent is selected from the group consisting of alkyl sulfates, such as sodium dodecylsulfate, ethoxylated alkyl sulfates, such as sodium lauryl ether sulphate, alkyl sulfonates, fatty acid salts, ethoxylated fatty acids, polyoxyethylene ethers, such as polyoxyethylene tridecylether and polyoxyethylene-10-stearyl ether or decaethylene glycol octadecyl ether, polyethylene glycols, polyethylene glycol methyl ether, polyethylene glycol methacrylate and other conventional non-ionic and ionic surfactants. The amount of the surfactant is typically 0.5-15, preferably 1-10% by weight calculated from the monomer.

The co-surfactant is selected from the group consisting long-chain hydrocarbons, such as hexadecane, 1-alcohols such as cetyl alcohol, and polymers soluble in the acrylate monomer, such as polymethyl methacrylates. The co-surfactant is typically used 0-8% by weight of the amount of the monomer.

The polymerising initiator (free radical initiator) is selected from the group consisting of persulfates, such as sodium, potassium and ammonium persulfate, benzoyl peroxide, 2,2′-azobisisobutyronitrile and other radical initiators, using typically concentrations of about 0.5-1.0% by weight of the monomer. The polymerising initiator is typically added as an aqueous solution, the amount of the initiator in the aqueous solution being typically 1-5, preferably 2-3.5% by weight. The aqueous solution of the polymerising initiator is typically added within 10 min-2 hours.

The average hydrodynamic radium (Rₕ) of particles of the acrylate-modified natural fatty acid based hybride polymer is 70-200 nm and size distribution 25-400 nm, average molecular weight M_{w} 8000-6000000 g/mol. Three glass transition temperatures are typically visible in the DSC curves of the hybride products. The glass transition temperature (T_{g}) can be determined by differential scanning calorimetry DSC.

The emulsion of the acrylate-modified natural fatty acid based hybride polymer can be further dispersed/emulsified with a modified or unmodified alkyd resin typically at a temperature of 20-80° C. under vigorous mixing. Thus an aqueous emulsion according to the invention is obtained, the dry matter content of which is 10-80, preferably 25-50% by weight.

Unmodified natural fatty acid based alkyd resin refers here to a condensation product of a polyhydric alcohol/alcohols and a mono-, di- and/or polyacid/-acids or anhydride and natural fatty acids or natural fatty acid esters. The natural fatty acid or natural fatty acid ester comprises a fatty acid mixture or fatty acid ester mixture selected from the group consisting of tall oil fatty acids, suberin fatty acids, cutin fatty acids, plant oils and their mixtures, preferably tall oil fatty acids, suberin fatty acids, linen seed, soy, rapeseed, rape, sunflower and olive oil.

Natural fatty acid based alkyd resin refers here to an alkyd resin prepared by condensing from 20-80, preferably 40-75% by weight of fatty acid starting material or a mixture thereof, in which the proportion of conjugated fatty acids can be 0-70% by weight, from 1-45, preferably 5-30% by weight of one or more polyols, from 5-45, preferably 10-39% by weight of one or more polybasic acids and optionally from 0-15% by weight one or more monobasic acids. The fatty acid starting material comprises natural fatty acid or natural fatty acid ester selected from tall oil fatty acids, suberin fatty acids, cutin fatty acids, plant oils and their mixtures, preferably tall oil fatty acids, suberin fatty acids, linen seed, soy, rapeseed, rape, sunflower and olive oil. The polyol is selected from glycerol, pentaerythritol, trimethylolpropane, neopentyl glycol and their mixtures. The polybasic acid is selected from the group consisting of di- and polyacids and their anhydrides, the polybasic acid is preferably phthalic anhydride, isophthalic acid or terephthalic acid. The monobasic acid is selected from the group consisting of aromatic monoacids and aliphatic C₄-C₂₀ carboxylic acids such as valeric acid (n-pentanoic acid) and benzoic acid.

The alkyd resin is prepared by esterifying the polyhydric alcohol(s), mono-, di-, and/or polyacid(s) or anhydride and the free fatty acid starting material(s) together under an inert gas at a temperature of 200-270° C., preferably 220-260° C.

When fatty acid esters such as plant oils are used, the fatty acid esters are first allowed to react with an excess of a polyol in an ester exchange reaction called alcoholysis at a temperature of 150-240° C., preferably 180-200° C., whereby free hydroxyl groups are obtained in the equilibrium mixture, which can react further with mono-, di- and/or polyacids or anhydrides at a temperature of 200-270° C., preferably 220-260° C., under an inert gas. Commonly used alcoholysis catalysts are lithium hydroxide, calcium oxide and sodium hydroxide. For the alcoholysis, the polyol is typically used twice the molar amount of the oil; the oil:polyol mole ratio is typically 1.0:1.2-1.0:3.0, preferably 1.0:1.5-1.0:2.0. The molecular weight of the alkyd resins is typically <20,000 g/mole, preferably 2,000-10,000 g/mole and the acid number is typically <25, preferably <15.

In the method according to the invention also natural fatty acid based alkyd resin can be used which has been modified with maleic anhydride or C₁-C₂₀ alkyl/alkenyl derivatives of maleic anhydride, or di- and half esters of maleic anhydride. The modifying is carried out so that the fatty acid based alkyd resin is warmed to a temperature of 100-200, preferably 150-180° C., maleic anhydride or its derivative (5-35 mole %, preferably 10-20 mole % of the fatty acid content of the alkyd) is then added in small portions during 0.5-2 hours, after which the reaction mixture is warmed to 150-220, preferably 180-200° C. and is agitated further for 1-5 hours. As the final product a modified alkyd resin is obtained having a higher acid functionality than the alkyd resin starting material.

The acrylate-modified natural fatty acid based hybride polymers according to the invention and their emulsion with alkyd resins are well suited as binding agents for coating and adhesive compositions, for tackyfier compositions in pressure sensitive adhesives and also as binding agents and compatibilisators for manufacture of biocomposites and for wood impregnating compositions.

Typical components used in coating and adhesive compositions in addition to binding agents are biocides, such as fungicides 0.2-1.2%, bactericides 0.2-0.5%, surfactants 0.1-2%, pigments and extenders 10-30% (inert fillers), thickeners 0.2-2% and water. The acrylate-modified natural fatty acid based hybride polymers according to the invention can also be used as components in pressure sensitive adhesives as such or, if desired, with known excipients. Self-adhesive adhesives or pressure sensitive adhesives are at room temperature in dry form aggressively persistent adhesives. They adhere to different materials without high pressure.

The acrylate-modified natural fatty acid based hybride polymers according to the invention can be used for wood impregnating applications by mixing 1-30%, preferably 5-15% of the product with tall oil fatty acid mixture or plant oils such as linen seed, soy or rapeseed oil or by using an aqueous emulsion, if required with known additives, for impregnation of wood and wood-derived products.

Additionally the acrylate-modified natural fatty acid based hybride polymer according to the invention can be used as a binding agent and compatibilisator in the preparation of combination products such as composites from natural materials such as cellulose, wood, wood fibres, linen, hemp, starch and other natural fibres or their combinations, if required with known additives.

The composite according to the invention containing acrylate-modified natural fatty acid based hybride polymer comprises 1-50, preferably 5-30% by weight (calculated from dry matter) of acrylate-modified natural fatty acid based hybride polymer, either as such or an aqueous emulsion, and 99-50, preferably 95-70% by weight of cellulose, wood, wood fibres, linen, hemp, starch or other natural fibres or combinations thereof. The composite according to the invention can be produced by mixing 1-50, preferably 5-30% by weight of acrylate-modified natural fatty acid based hybride polymer and 99-50, preferably 95-70% by weight of cellulose, wood, linen, hemp, starch or other natural fibres or a combination thereof and by forming and hardening the product with aid of heat, e.g. by extruding or heat-pressing at 100-250° C., preferably 120-200° C. to a composite product of desired type.

The acrylate-modified natural fatty acid based hybride polymers according to the invention have several advantages. In coating applications such as paints the dry matter content of the coating can be increased with aid of them to even 40-60% by weight, which is considerably higher than the dry matter content, which is typically used with a product produced by direct emulsifying from an alkyd resin. Additionally, the amount of emulsifiers and surfactants, which impair the properties of paints, can be reduced considerably in the paint compositions. These surfactants typically migrate to the surface of the paint film where they act like plastisizers, resulting in that the paint film becomes softer and sticky, additionally water resistance and chemical resistance are impaired.

The use of the hybride polymers according to the invention in coatings reduces substantially the emissions of volatile organic substances from the products in question, because the need for using other solvents and excipients is substantially reduced when compared to traditional alkyd resins.

Because the components of the hybride polymer originate from a natural fatty acid or natural fatty acid ester containing double bonds, the compositions containing hybride polymers dry quickly and conjugation enhances the drying. The coatings have excellent gloss and hardness and the coatings are also remarkably well suited for treatment of modified wood such as thermo wood, because the hybride polymers are compatible with natural materials such as the own components of wood.

The use of the hybride polymer according to the invention as binding agent in natural fibre based composites such as linen, wood and hemp composites will promote the natural properties, biodegradability and non-toxicity of the product. Additionally, the hybride polymer according to the invention is a reactive binding agent, which improves the physical properties of the composite, such as strength, water resistance and solvent resistance as well as the adhering to the matrix material and even distribution in the product.

When the reactive hybride polymer according to the invention is used either as such or together with plant oils, for impregnation of wood, the leaking out of the impregnating agent from wood will decrease and adhesion to the wood is facilitated.

In the method according to the invention, a smaller molecule is the starting material, to which an acrylate polymer segment is polymerised. This results in that the dispersibility to the media typically used and the compatibility with other components of the product will improve.

The invention is described in more detail with the following examples, to which it is anyhow not meant to be restricted.

### EXAMPLES

### Example 1

### Preparation of Acrylate-Modified Natural Fatty Acid Based Hybride Polymer from Linen Seed Oil

Into 150 g of linen seed oil 3 g of sodium dodecyl sulfate and 15.0 g of Brij 76 (decaethyleneglycol octadecyl ether) were mixed. The mixture was agitated at 60° C., whereby the mixture turned homogeneous. The mixture was neutralised with 15 ml of 1M sodium bicarbonate. 170 g of butyl acrylate and 12.1 g of hexadecane were mixed together and added slowly to the former. 450 ml of water was added drop wise to the monomer mixture and warming was discontinued. The emulsion was mixed further with a magnetic stirrer and for about 5 min with Ultra Turrax homogeniser, 13,500 rpm. After this the emulsion was added to a glass reactor and nitrogen flow was connected to the reactor. The bath was warmed to 75° C. with a speed of revolution of 430 rpm. When the inner temperature of the reactor was 50° C., 20 ml/min of initiator solution (5.1 g of potassium persulfate and 150 ml of water) was added to the reactor. After 4 hours of polymerisation (inner temperature about 69-70° C.) the temperature was lowered to about 30° C. and the emulsion obtained as product was drained from the reactor. The dry matter content of the emulsion was 36% by weight.

### Example 2

### Preparation of a Tall Oil Based Alkyd Resin

Alkyd resin was prepared from tall oil fatty acids (1484.4 g), isophthalic acid (222.4 g) and trimethylolpropane (375.5 g). All starting materials were weighed to a reactor, the reaction mixture was agitated and warmed at 250-260° C. under nitrogen flow. The progress of the reaction was followed with aid of samples, wherefrom acid number, and when the reaction mixture became clear, also viscosity (R.E.L. rotating cone/plate viscometer). The reaction was boiled for 11 hours. The acid number of the cooled product (1875.2 g) was 10.3 mgKOH/g and viscosity 2.4 Poise/50° C.

### Example 3

### Preparation of Linen Seed Oil Based Alkyd Resin

Alkyd resin was prepared from linen seed oil (865.7 g), trimethylolpropane (402.0 g), isophthalic acid (300.0 g) and benzoic acid (294.3 g). 860 g of linen seed oil was warmed to a temperature of 150° C., agitating under nitrogen atmosphere. Lithium hydroxide monohydrate was added as suspended to 5.7 g of linen seed oil. Warming was continued to 200° C. and trimethylolpropane was added. The alcoholysis reaction was followed with aid of a solubility test. When the reaction mixture was fully soluble in methanol, isophthalic acid was added into the reaction vessel, and after mixing benzoic acid was added. The warming of the reaction mixture was continued at 200-250° C. and the progress of the reaction was followed with aid of the acid number, and when the reaction mixture became clear, also with aid of the viscosity. The reaction was boiled for 3.5 hours from the acid addition. From the cooled product (1584 g) acid number (14 mgKOH/g)) and viscosity (5.4 Poise/50° C., R.E.L. rotating cone/plate viscometer) were determined.

### Example 4

### Modification of Tall Oil Fatty Acid Based Alkyd Resin with Maleic Anhydridride

Starting material, the alkyd manufactured in example 2 (400 g, acid number 10.3 mgKOH/g, viscosity 2.4 Poise/50° C.) was weighed to a reaction vessel and the reaction mixture was warmed to 180° C. Maleic anhydride (8.0 g, 0.163 mol, 15 mol % calculated from fatty acid content of the alkyd) was added in small portions during 1 hour, then the reaction mixture was warmed to 200° C. and agitated still for 3 hours. 396.9 g of the final product was obtained, having acid number of 19.7 mgKOH/g and viscosity of 4.7 Poise/50° C.

1-11. (canceled)

12. Acrylate-modified natural fatty acid based hybride polymer, characterised in that it is a polymer formed of acrylate segments originating from acrylate monomers and fatty acid segments originating from fatty acid starting material containing double bonds, having molecular weight of 800-6000000, and in which the fatty acid segment having molecular weight of 200-2,000 comprises fatty acids or mono- and/or oligoesters of fatty acids, and the hybride polymer is manufactured by a method where acrylate monomer(s), mixture of natural fatty acid(s) or mixture of natural fatty acid ester(s) and one or more surfactants and optionally one or more co-surfactants are mixed at a temperature of 20-80° C., then pH of the mixture is adjusted between 6-9 with a base, then the reaction mixture is then emulsified to an aqueous emulsion optionally containing one or more surfactants, and agitated, the emulsion is then warmed to a temperature of 30-90° C. and polymerisation is carried out at 30-100° C. in the presence of a polymerising initiator with mixing rate of 100-2000 rpm.

13. The acrylate-modified natural fatty acid based hybride polymer according to claim 12, characterised in that the fatty acid starting material is selected from natural oils, tall oil fatty acid mixtures and fatty acid mixtures of suberin and cutin.

14. The acrylate-modified natural fatty acid based hybride polymer according to claim 12, characterised in that the fatty acid starting material is selected from fatty acid mixtures of suberin.

15. The acrylate-modified natural fatty acid based hybride polymer according to claim 13, characterised in that the natural oil is selected from linseed oil, soy oil, rapeseed oil, rape oil, sunflower oil and olive oil.

16. The acrylate-modified natural fatty acid based hybride polymer according to claim 12, characterised in that the acrylate monomer(s) is/are selected from butyl, ethyl, methyl and 2-ethylhexyl acrylates, and butyl, ethyl, methyl and 2-ethylhexyl methacrylates, acrylic and methacrylic acids and mixtures thereof, mixtures of acrylate monomers, and mixtures of acrylate and methacrylate monomers with styrene or vinyl alcohol or vinyl acetate.

17. A method for preparing acrylate-modified natural fatty acid based hybride polymers, characterised in that acrylate monomer(s), mixture of natural fatty acid(s) or mixture of natural fatty acid ester(s) and one or more surfactants and optionally one or more co-surfactants are mixed at a temperature of 20-80° C., then pH of the mixture is adjusted between 6-9 with a base, then the reaction mixture is then emulsified to an aqueous emulsion optionally containing one or more surfactants, and agitated, the emulsion is then warmed to a temperature of 30-90° C. and polymerisation is carried out at 30-100° C. in the presence of a polymerising initiator with mixing rate of 100-2000 rpm.

18. The method according to claim 17, characterised in that the natural fatty acid(s) or natural fatty acid ester(s) is/are selected from natural oils, tall oil fatty acid mixtures and a fatty acid mixture of suberin and cutin.

19. The method according to claim 18, characterised in that the natural oils are selected from linseed oil, soybean oil, rapeseed oil, rape oil, sunflower oil and olive oil.

20. The method of according to claim 17, characterised in that the acrylate monomer(s) is/are selected from butyl, ethyl, methyl and 2-ethylhexyl acrylates, butyl, ethyl, methyl and 2-ethylhexyl methacrylates, acrylic and methacrylic acid and mixtures thereof, acrylate monomer mixtures, and mixtures of acrylate and methacrylate with styrene or vinyl alcohol or vinyl acetate.

21. A method for the preparation of an emulsion/dispersion, characterised in that the acrylate-modified natural fatty acid based hybride polymer according to claim 12 or prepared with the method according to claim 17 is added to an alkyd resin and pH of the mixture is adjusted between 6-9 with a base and the mixture is dispersed/emulsified into water at a temperature of 15-80° C. and optionally with 0-30% by weight of a co-solvent.

22. Use of the acrylate-modified natural fatty acid based hybride polymers according to claim 12 or prepared according to the method according to claim 17 or of the emulsion prepared according to the method according to claim 21 as binding agents in coatings, adhesives, paints and as components in pressure sensitive glues, as binding agents and compatibilisators in composites and as wood impregnating agents.
